(19) United States
(12) Patent Application Publication
(10) Pub. No.: US 2018/0160622 A1
(43) Pub. Date: Jun. 14, 2018

(54) ELECTRIC MOWER WITH MULTIPLE BLADES

(71) Applicant: PELLENC (Societe Anonyme), Pertuis (FR)

(72) Inventor: Roger PELLENC, Pertuis (FR)

(21) Appl. No.: 15/568,146

(22) PCT Filed: Jun. 23, 2016
(86) PCT No.: PCT/FR2016/051540

§ 371 Date: Oct. 20, 2017

(30) Foreign Application Priority Data
Jul. 27, 2015 (FR) 1557162

(51) Int. Cl. A01D 34/78; A01D 34/69; A01D 34/74; A01D 34/685; A01D 34/81; A01D 34/00; A01D 43/063

(52) U.S. Cl. CPC A01D 34/78; A01D 34/69; A01D 34/74; A01D 34/824; A01D 34/81; A01D 34/006; A01D 43/063; A01D 34/685

(57) ABSTRACT

An electric mower includes a cutting unit with: a cutting plate provided with at least two cutting blades mounted respectively on blade shafts; a casing attached to the cutting plate; at least one electric motor driving the cutting blades; and a blade-synchronisation mechanism. The electric motor is arranged in the casing between the cutting plate and the blade-synchronisation mechanism.

### TECHNICAL FIELD

The present invention concerns a mower such as a lawn mower or a brush mower. It concerns more specifically a mower with more than one blade. It may in particular be a mower with two or three blades.

In other respects, the invention concerns mowers with an electric cutting unit, which is to say mowers with blades driven by an electric motor.

The invention finds applications in the technical field of walk-behind lawnmowers, of riding lawnmowers, remotely controlled mowers and in the field of autonomous robotic mowers.

### STATE OF PRIOR ART

Although not referring to mowers with an electric cutting unit, an illustration of the state of the art of multi-blade mowers is given for example by the following documents:
FR 2 601 844
FR 2 915 846
FR 2 589 668
U.S. Pat. No. 2,464,886.

Mowers with multiple rotary blades of the type illustrated by these documents are generally mowers of considerable size. Also, and because of the number of blades they are equipped with, these lawnmowers are generally provided with powerful thermal engines. With the exception of towed mowers, the thermal engine serves to drive the blades and to propel the mower.

The invention proposes to take advantage of new generations of high capacity batteries for the production of multi-blade mowers with electric motors.

### DISCLOSURE OF THE INVENTION

Equipping multi-blade mowers with an electric motor does not mean to simply replace a thermal engine with an electric motor.

In effect, and in conformance with the invention, utilization of an electric motor goes together with measures which favor a significant reduction in the overall space requirement and the mass of the mower. Furthermore, using batteries goes generally together with achieving high energy yields to obtain the greatest operating autonomy possible. These measures permit utilization of a multi-blade mower in applications comparable to those of lightweight single-blade mowers while affording greater cutting widths. Cutting widths of 60 cm or more can be obtained with a multi-blade mower, whereas a cutting width of an electric mower with a single blade is generally in a range below 50 cm.

One aim of the invention is to propose an especially compact and manageable mower in spite of its considerable cutting width and permitting its configuration as a riding mower, walk-behind mower, remotely controlled mower or even an autonomous robotic mower. These latter configurations are generally impractical for known multi-blade mowers due to their size and weight.

One aim of the invention is also to propose a lightweight mower that is easy to clean and maintain.

Still another aim is to propose an electric mower with a limited number of electrical wires and connections.

Finally, another aim of the invention is to propose a mower that is especially reliable and durable.

To achieve these aims, the invention proposes an electric mower comprising a cutting unit with:
a cutting plate equipped with at least two cutting blades respectively mounted on blade shafts,
a casing fixed on the cutting plate,
at least one electric motor for driving the cutting blades,
a blade synchronization mechanism.

In accordance with the invention, the electric motor is installed in the casing between the cutting plate and the blade synchronization mechanism.

The characteristic of the invention according to which the electric motor for driving the blades is located between the cutting blade and the blade synchronization mechanism allows for an especially compact and efficient design of the cutting unit.

In the following description, reference is made primarily to a single electric motor. It should however be noted that one electric motor may be associated to each blade. In this case all motors used for driving the blades are located in the casing between the cutting plate and the synchronization mechanism.

The electric motor is preferably so positioned that its rotary axis is perpendicular to the cutting plane in which the cutting blades rotate. In an operating position of the mower the motor axis is therefore essentially vertical.

The motor axis may correspond to the axis of a shaft of the cutting blade. This aspect is described in greater detail in the text below.

The cutting unit preferably comprises several vertically superposed stages or levels. A first level which is near the ground in a working position of the mower corresponds to the cutting plate. It includes the cutting blades. The blades are mounted for rotation on blade shafts extending along axes essentially perpendicular to a cutting plane. The blades thus extend along a plane that is essentially parallel to the ground. To each blade corresponds a circular working area situated in the cutting plane The working areas of the different blades may present one or several overlapping areas that are covered by two adjacent blades respectively. In the case where the blades have the same length, this means that the blade shafts are apart by a dimension that is inferior to the length of a blade.

Above the first blade level, a second level receives a casing comprising the blade drive motor. The second level also extends along a plane essentially parallel to the ground, in a working position of the mower.

Above the second level, a third level holds the blade synchronization mechanism. Preferably, the elements of the synchronization mechanism are also fitted into the casing and in a plane essentially parallel to the ground.

A possibly present fourth level, above and in proximity to the third level may hold an electronic control unit for the mower and in particular of the electric motor. Preferably, the forth level constitutes the high portion of the casing and may consist of a casing cover containing the electronic control unit of the mower.

Finally, a possibly present fifth level, above the fourth level, or at the place of the fourth level, may hold one or several batteries for the power supply to the motor. The battery, however, is not necessarily part of the cutting unit and may be located elsewhere on the mower. Preferably, the levels one to four constituting the cutting unit and in particular the cutting plate, the casing and the casing cover are rigidly integral with each other.

The synchronization mechanism may have several functions. One major function is the mechanical synchronization of the blades. Synchronization of the blades enables the blades to rotate in concert, at the same rotation speed and while keeping a constant angular clearance between the angular positions of the adjacent blades.

A constant clearance between the angular positions of the adjacent blades in their working areas prevents the blades from colliding with each other, especially when the working ranges present an area where they mutually overlap. The angular clearance of adjacent blades is preferably in the order of 90°, and in any case sufficient to prevent the blades from coming into collision with each other during rotation or from squeezing the vegetation to be cut.

The mower may feature an electronic control unit of the blade drive motor(s). In case of a plurality of blade drive motors, the electronic control unit is also configured for synchronizing the rotation of the electric motors associated to the various cutting blades.

In this case the blades benefit from dual mechanical and electrical synchronization. A second function of the synchronization mechanism of the blades may be to transmit the movement of the electric motor to all the blades of the cutting unit. The synchronization mechanism then constitutes a transmission. The transmission function is important when the cutting unit comprises only one single electric blade drive motor the movement of which needs to be distributed to the various blades.

According to a particular implementation of the mower, it may feature a frame forming a chassis. The frame is preferably a tubular frame extending along a plane essentially horizontal in an operating position of the mower. In this case, a part of the cutting unit including the electric motor and the synchronization mechanism, and in particular the second, third and fourth levels of the cutting unit, may be configured to extend across the tubular frame, so as to protrude above the tubular frame. The first level, as far as it is concerned, remains below the plane of the frame.

Such a layout allows for a particularly compact and manageable design of the mower.

The cutting unit may be mounted in mobile fashion on the frame with a possibility of displacement along an axis perpendicular to the plane of the frame. Displacement of the cutting unit therefore occurs essentially in a direction perpendicular to the ground, in an operating position of the mower.

Thus, the height of the cutting unit relative to the plane of the frame is variable. By modifying the height of the cutting unit relative to the frame, it is possible to adjust the distance between the cutting blades and the ground on which the mower rests, and thus to set a desired cutting height.

The possibility of directly setting the cutting height by means of the mobility of the cutting unit allows the use of wheels that are at a fixed height relative to the frame. The wheels may also be mounted on the frame. This measure serves to increase the sturdiness of the wheel fastening and facilitates any wheel replacement during a maintenance operation.

The cutting unit may be mounted on the chassis of the mower by means of a mounting in form of a parallelogram, ramp or sliders, or in another appropriate manner so as to enable its height adjustment. Height adjustment is feasible while mowing, and without stopping the machine.

Furthermore, the mower may feature at least one electric jack for displacing the cutting unit relative to the frame. Using an electric jack facilitates modifying the cutting height during the mowing operation. It even permits continuous adaptation of the cutting height, if necessary.

As stated earlier, the cutting unit features a casing fastened on the cutting plate. The casing may enclose the motor, the blade synchronization mechanism and a control unit of the mower. The casing is fixed rigidly on the cutting plate and preferably on a protective skirt of the blades of the cutting plate, so as to form a monolithic unit.

The fact that the cutting plate is attached to the casing rather than being formed of a single piece with the casing makes it possible to replace the cutting plate, and in particular the blade protection skirt should it become damaged.

Advantageously, a part of the casing which forms the housing for the electric motor may be configured to extend partially into the cutting plate. In particular, when the cutting plate includes a blade protection skirt, the part of the casing which forms the housing for the motor may present journals which traverse the skirt.

The fact that a part of the casing extends into the cutting plate makes it possible to bring this part closer to the cutting blades and thus to cool the casing and the elements contained in it by an air flow generated by the cutting blades. In particular the air from the cutting blades can advantageously be used to cool the motor and the control unit housed in the casing.

The casing is preferably made of aluminum or a light aluminum-based or magnesium-based alloy. Such material is both solid and a good heat conductor. Thereby it promotes cooling of the elements contained in the casing and constitutes a dust-tight casing thus preventing the electric motor from becoming soiled.

The casing may also be made of a plastic material which is more economical but its heat-conducting capacity is not as good.

According to a particularly advantageous layout of the cutting unit, the control unit includes an electronic motor control card placed just above the synchronization mechanism. The electronic card is provided with a magnetic sensor, for example a magneto-resistive sensor or a Hall-effect sensor cooperating with a magnet integral with either a cutting blade shaft, an electric motor shaft or a shaft of the synchronization mechanism. Preferably the magnet is directly integral with the shaft of the electric motor.

The magnetic sensor allows measuring the angular position of the magnet. The electronic card uses the measure of the magnetic sensor to determine, among other things, the angular position of the motor rotor and to control the power supply of the motor. Such a controlled power supply is primarily used for brushless electric motors.

Locating the control unit and the electronic card just above the synchronization mechanism allows mounting the magnetic sensor directly on the electronic card. Thereby a wire connection between the sensor and the electronic card can be avoided, thus improving the compactness of the cutting unit. Reliability of the motor control is also greatly improved.

The signal of the magnetic sensor can also be used to determine other parameters such as effective rotation speed of the cutting blades, or blocking of the blades, for example.

Furthermore, according to an advantageous layout of the cutting unit, the casing may be provided with a removable cover providing access to the control unit and the synchronization mechanism. The cover greatly facilitates maintenance operations and in particular lubrication of the rotating parts of the cutting unit.

The cutting blades are mounted on rotary shafts resting on bearings. In conformance with a particular embodiment of the cutting unit, the bearings may be mounted in the casing. The stresses of the blades are thus transmitted to the frame forming a chassis through the intermediary of the casing of the cutting unit.

In a particular embodiment of the cutting unit, the blade shafts present respectively a first end for the installation of a cutting blade and a second end, opposite the first end, being connected to the synchronization mechanism, so as to maintain a constant angular distance between the cutting blades in the manner indicated above.

The synchronization mechanism may be a notched belt mechanism. In this case, the second end of the blade shafts is respectively connected to a toothed pulley cooperating with the notched belt.

The synchronization mechanism may also be a geared mechanism. In this case, the second end of the blade shafts is respectively connected to a toothed wheel cooperating with the gear.

The synchronization mechanism may also be a mixed mechanism with gear and notched belt. In this case, the second end of the blade shafts is respectively connected to a toothed pulley cooperating with a notched belt connected to an intermediary assembly with toothed pulley and gear.

In a configuration of the cutting unit with a single motor, a first cutting blade may be mounted on a blade drive shaft rigidly integral in rotation with a rotor of the electric motor, and at least one second cutting blade may be mounted respectively on at least one secondary blade shaft coupled to the drive shaft through the intermediary of the synchronization mechanism. In this case, and as indicated previously, the synchronization mechanism forms a transmission between the drive shaft and the secondary shaft(s).

The electric motor thus presents an output shaft which is the blade drive shaft.

In a particular implementation of a mower in accordance to the invention, the cutting plate may feature two counter-rotating blades and a blade projection skirt provided with a central ejection channel. The rotary movement of the blades is used for mowing and also for the ejection of the grass clippings through the central ejection channel.

Utilization of the counter-rotating blades and a central ejection channel contributes to the compactness of the mower.

The mower may, incidentally, be equipped with a removable collection bag, connected to the central ejection channel.

In order to facilitate its assembly and in the interest of compactness, the grass collection container may be fastened on the cutting unit. The collection container is then vertically removable relative to the frame together with the cutting unit.

The mower may be equipped with driven rear wheels coupled to the electric motor so as to ensure the forward movement of the mower. The coupling may be done in the classic manner over a transmission box.

The mower may also be equipped with driven rear wheels coupled to at least one electric motor separate from the electric motor driving the cutting blades. In particular, each wheel may be coupled to its own drive motor.

Other characteristics and advantages of the invention become clearer in the following description in reference to the numbers on the drawings. This description is given for purely illustrative purposes and is not limiting.

### BRIEF DESCRIPTION OF THE FIGURES

FIG. 1 is a general view of a mower according to the invention.

FIG. 2 is a side view of the mower of FIG. 1, a bin for collecting grass clippings having been removed and a handlebar being folded back to the storage position.

FIG. 3 is a cross-section of a cutting unit of a mower according to the invention, seen along a plane A-A of FIG. 2.

FIG. 4A is a simplified view of a particular implementation of a geared synchronization mechanism of the cutting unit.

FIG. 4B is a simplified view of a particular implementation of a mixed synchronization mechanism with gears and notched belt of the cutting unit.

FIG. 4C is a schematic view of a particular implementation of a synchronization mechanism with notched belt of the cutting unit.

### DETAILED DESCRIPTION OF IMPLEMENTATIONS OF THE INVENTION

In the following description identical, similar or equivalent parts of the various figures are identified with the same reference numbers so as to be able to refer from one figure to the next.

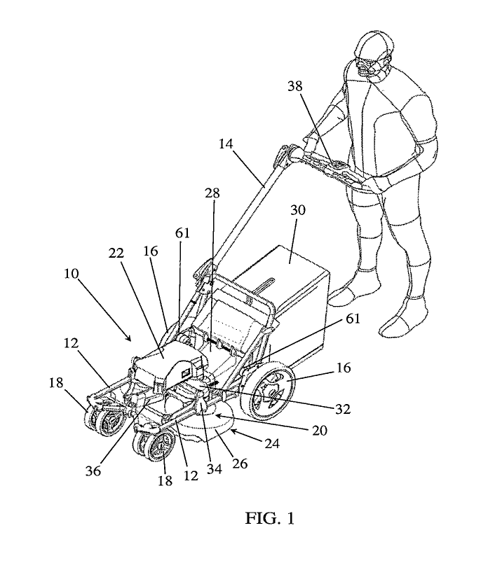

Incidentally, the terms “horizontal”, “vertical”, “high”, “low”, “superior”, “inferior”, “above” and “below”, “front” and “rear” are used in reference to a position and a normal utilization of the walk-behind mower on a flat and horizontal terrain, corresponding to FIG. 1.

FIG. 1 shows a particular embodiment of a lawnmower 10 in conformance with the invention. It is a walk-behind mower. It is appropriate to mention that the invention can also be applied to a riding mower, remotely controlled mower or robotic autonomous mower.

The mower 10 comprises a frame 12 forming the chassis on which are fitted various elements. The frame extends essentially in the horizontal plane. It is preferably weldless, with tubing elements assembled with screws and by adapted sleeves. The frame holds essentially an articulated handlebar 14, rear driving wheelsl6, freely swiveling front wheels 18, a cutting unit 20 and a battery 22 located above the cutting unit 20.

The swiveling front wheels 18 are mounted on the frame with vertical pivoting range of 360°. These are dual wheels in the example shown. The rear drive wheels 16 are each provided with an electric motor 61 for propelling the mower forward.

The cutting unit 20 includes a cutting plate 24. The term cutting plate applies to an assembly including essentially the cutting blades, not visible in the figure, and a blade protection skirt 26. In the example shown, the cutting plate 24 is a plate with two counter-rotating blades. The term counter-rotating blades applies to blades that rotate in the opposite direction to each other. The opposite movement of the blades is used to evacuate the grass clippings.

The cutting plate extends in effect, behind the blades, in the form of an ejection channel 28 for the grass clippings with a removable collecting bin 30 for the clippings connected to it. In the example shown the bin 30 is attached to the cutting unit.

A casing 32 of the cutting unit 20, made of a light alloy, constitutes an upper part of the cutting unit 20. The casing 32 is above the cutting plate 24 and extends through the tubular frame 12. The cutting unit is located under a bridge frame 34, mounted on the tubular frame 12, provided for installation of the battery 22. The battery 22 is provided for the power supply to the motor of the cutting unit and to the motors 61 of the rear wheels.

At the front of the mower, one can observe an electric jack 36 provided for a vertical movement of the cutting unit relative to the frame 12. Operation of the jack can be controlled by a guiding unit of the mower or through the intermediary of a manual control interface 38 attached to the top of the handlebar 14.

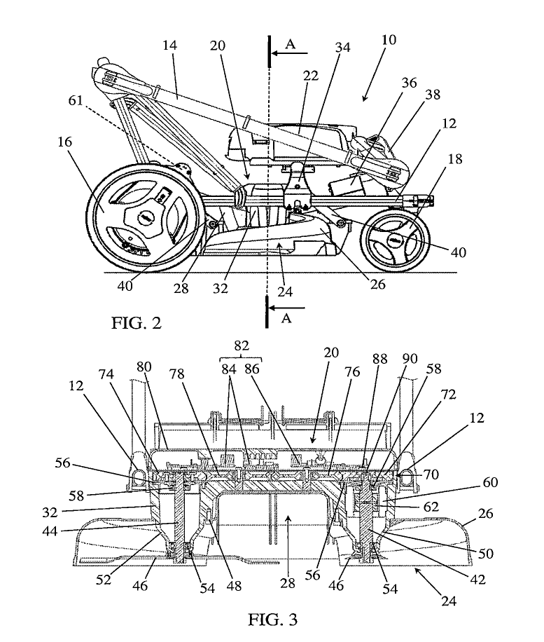

FIG. 2 is a side view of the mower in FIG. 1 on which the clippings collecting bin 30 has been removed and on which the handlebar 14 is shown in the folded-back position. On FIG. 2, one can better see the passage from the upper part of the cutting unit 20 through the frame 12, below the battery 22. The cutting unit 20 is maintained on the frame 12 through the intermediary of small rods 40 forming a suspension parallelogram. The rods 40 are mounted so that they can pivot both on the frame 12 and on the cutting plate 24 on top of the skirt 26. Activation of the jack 36 lifts or lowers the cutting unit. It is worth noting that, according to this implementation, the vertical displacement of the cutting unit 20 in relation to the frame 12 is accompanied by a pivot of the rods and hence by a slight horizontal displacement while ensuring the displacement of the cutting plate parallel to the frame. By the vertical displacement of the cutting unit 20 the cutting height can be adjusted.

FIG. 3 is a cross-section of the cutting unit along the plane A-A of FIG. 2 passing through the motor and the blade shafts 42, 44. The blade shafts extend along vertical and parallel axes. Each blade shaft 42, 44 presents a first end on which a blade 46 is mounted. In the example shown, the two blades 46 are mounted on the blade shafts with a relative angular spacing of 90°. A distance between the blade shafts 42, 44 is a little less than the length of a blade 46. Thus, the working areas of the blades present an overlapping area in the middle of the cutting plate, facing the ejection channel 28 for grass clippings.

The blade protection skirt 26 is rigidly attached to the casing 32, by means of screws 48 and it protects the inside face of the casing turned towards the blades. The skirt is preferably made of aluminum, a light alloy based on aluminum or magnesium, or of plastic material. It can be replaced when it is deteriorated.

The casing 32 presents, above each blade, a journal 50, 52 for passage of the shaft the low end of which traverses the skirt 26. The journals are provided at their low ends respectively with a bearing 54 for maintaining the blade shaft. The upper end of the journals is topped respectively by a cover 56, also provided with a bearing 58 for maintaining the blade shafts in their upper part.

In the example of implementation shown in FIG. 3, the first journal 50 receiving the blade shaft 42 contains an electric motor 60 for driving the blades. It is a brushless motor with a rotor 62 rigidly integral with the first blade shaft 42. The first blade shaft 42 is called the “motor blade shaft”. The second journal 52 forms a seat capable of accepting an electric motor for the second blade comparable to the electric motor 60 of the journal 50. However, in the example described in reference to FIG. 3, the seat of the second spindle 52 does not contain a motor. The second blade shaft 44 which passes through the second spindle 52 is called “the secondary blade shaft” in the text below.

Above the journals and the motor 60 is a synchronization mechanism 70. The synchronization mechanism has a dual function in the example of implementation described in reference to FIG. 3. A first function is to guarantee a constant angular distance between the blade shafts 42, 44 and between the blades 46 mounted on them, during the rotation of the blades 46. A second function is the transmission of the movement of the motor blade shaft 42 to the secondary blade shaft 44 so that the electric motor 60 can drive the two blades 46. When a second electric motor occupies the second journal 52, the transmission function becomes less important or even superfluous, to the extent where each blade can be moved by its own motor. On the other hand, the synchronization function remains essential in order to avoid that the blades collide. The motor blade shaft 42 and the secondary blade shaft each present at their upper end, opposite the blade, a toothed wheel 72, 74. Two intermediate toothed wheels 76, 78 transmit the movement of the toothed wheel 72 of the motor blade shaft 42 to the toothed wheel 74 of the secondary blade shaft 44. The intermediate toothed 76, 78 are mounted on pivots integral with the casing 32 through the intermediary of bearings. The use of two intermediate toothed wheels allows obtaining counter-rotating blades, the motor blade shaft 42 and the secondary blade shaft 44 having opposite directions of rotation. The direction of rotation of the blades is such that the movement of the blades draws the grass clippings into the ejection channel 28.

A cover 80 closes the upper part of the casing 32. The cover holds a control unit 82 of the mower. The control unit 82 comprises electronic cards 84 for the control of the drive motors of the driven rear wheels and, if applicable, electronic cards controlling the displacement of the mower according to a robotic autonomous mode of progression. The control unit 82 also includes an electronic card 86 for the control of the electric motor driving the blades. The electronic card 86 includes in particular field effect transistors for the commutation of the supply currents of the electric motor 60.

In the example of implementation described in reference to FIG. 3, the electric motor 60 is a brushless motor. Now, for such a motor it is necessary to know the position of the rotor in order to establish the supply currents of the stator and thereby control the rotation of the rotor.

The electronic card 86 includes for this effect a magnetic sensor 88, such as a magneto-resistive sensor or a Hall-effect sensor, directly welded on the card and maintained by the card opposite a small magnet 90 seated in a boring of the upper end of the motor blade shaft 42. The sensor retained in the described solution is a Hall-effect sensor. The magnet 90 is driven in rotation by the motor blade shaft 42 and thus reflects the angular position of the rotor. In effect, and as indicated previously, the rotor of the electric motor 60 is integral with the motor blade shaft 42. The rotation of the magnet 90 in front of the Hall-effect sensor 80 thus generates a directly exploitable electric signal to determine the supply currents of the motor.

The signal of the Hall-effect sensor can also be exploited by the electronic card 86 in order to determine supplementary parameters for controlling the mower such as blade rotation speed, blade blocking or a motor overload.

When the cutting unit is provided with two motors, one for each blade, the electronic motor control card can also be configured for electronic synchronization of the motors. Electronic synchronization makes it possible to relieve the synchronization mechanism and reduce any loss of energy in this mechanism.

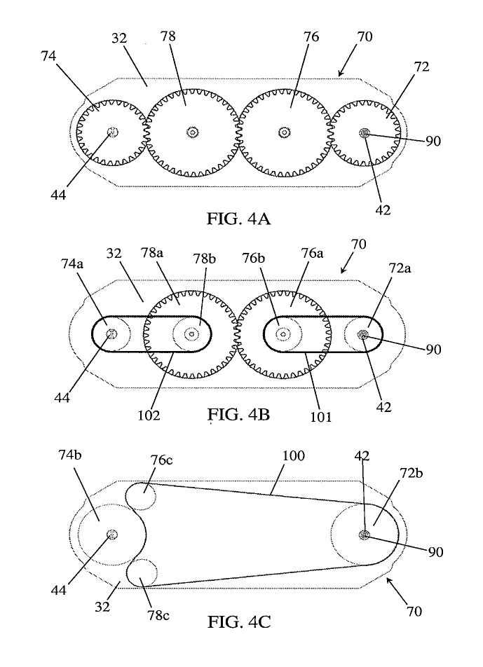

FIG. 4A schematically represents the synchronization mechanism 70 seen from above. One distinguishes there the toothed wheel 72, integral in rotation with the motor blade shaft 42, two intermediate toothed wheels 76, 78, mounted in free rotation on pivots, and a toothed wheel 74 integral in rotation with the secondary blade shaft 44. In this manner, a clockwise rotation of the toothed wheel 72 results in counterclockwise rotation of the toothed wheel 74, ensuring the counter-rotary movement of the cutting blades.

FIG. 4B schematically represents another possibility of creating a mixed synchronization mechanism 70 with a notched belt and toothed wheels. The toothed wheels 72 and 74 are replaced by notched pulleys 72a, 74a. The notched pulleys are respectively integral in rotation of the blade shafts 42, 44. The intermediate toothed wheels 76 and 78 of FIG. 4A are here replaced with integral units of toothed wheel and notched pulley 76a, 76b and 78a, 78b associated with two notched belts 101 and 102. In this manner, a clockwise rotation of the notched pulley 72a results in a clockwise rotation of the notched pulley 76b and of the toothed wheel 76a through the intermediary of the notched belt 101. The toothed wheel 78a, meshed on the toothed wheel 76a is driven in the counterclockwise direction. The notched pulley 78b, integral in rotation with the toothed wheel 78a, results in counterclockwise rotation of the notched belt 102 and thereby the notched pulley 74a. The mixed synchronization mechanism thus ensures the counter-rotating movement of the cutting blades.

FIG. 4C schematically represents another possibility of creating a synchronization mechanism 70 with notched belts. The toothed wheels 72 and 74 are replaced with notched pulleys 72b, 74b. The notched pulleys are respectively integral in rotation with the blade shafts 42, 44. The intermediate toothed wheels 76 and 78 of FIG. 4A are here replaced with a notched belt 100 associated to intermediate notched pulleys 76c and 78c. In this manner a clockwise rotation of the notched pulley 72b results in a counterclockwise rotation of the notched belt 100 and thus of the notched pulley 74c, ensuring the counter-rotating movement of the cutting blades.

1. Electric mower comprising a cutting unit with:
a cutting plate provided with at least two cutting blades mounted respectively on blade shafts;
a casing fastened on the cutting plate;
at least one electric motor for driving the cutting blades; and,
a blade synchronization mechanism;
in which the electric motor is installed in the casing between the cutting plate and the blade synchronization mechanism.

2. Electric mower according to claim 1, comprising a frame forming the chassis, the tubular frame extending along an essentially horizontal plane in an operating position of the mower, and in which a part of the cutting unit comprising the electric motor and the synchronization mechanism is configured to extend through the frame.

3. Electric mower according to claim 1, in which the cutting unit is mounted movably on the frame with a possibility of displacement along an axis perpendicular to the plane of the frame.

4. Electric mower according to claim 3, comprising at least one electric jack for displacement of the cutting unit relative to the frame.

5. Electric mower according to claim 1, in which the casing encloses the electric motor, the blade synchronization mechanism, and a mower control unit.

6. Electric mower according to claim 1, in which a part of the casing forming a seat for the electric motor, extends partly into the cutting plate.

7. Electric mower according to claim 6 in which the cutting plate comprises a protection skirt for the cutting blades and in which the part of the casing forming a seat for the motor presents spindles traversing said skirt.

8. Electric mower according to claim 7, in which the control unit comprises an electronic card for control of the electric motor, the electronic card being positioned above the synchronization mechanism and the electronic card being provided with a magnetic sensor such as a magneto-resistive sensor or a Hall-effect sensor cooperating with a magnet integral with either a cutting blade shaft a shaft of the electric motor or a shaft of the synchronization mechanism.

9. Electric mower according to claim 7, in which the casing comprises a removable cover giving access to a control unit and the synchronization mechanism.

10. Electric mower according to claim 7, comprising mounting bearings of the cutting blade shafts, the bearings being mounted in the casing.

11. Electric mower according to claim 7, in which the casing is a casing made of a light alloy.

12. Electric mower according to claim 1, in which the blade shafts present respectively a first end for the installation of a cutting blade and a second end, opposite the first end, the second end being connected to the synchronization mechanism so as to maintain a constant angular space between the cutting blades.

13. Electric mower according to claim 12, in which the synchronization mechanism is a mechanism with a notched belt and in which the second end of the blade shafts is respectively connected to a notched pulley cooperating with the notched belt.

14. Electric mower according to claim 12, in which the synchronization mechanism is a geared mechanism and in which the second end of the blade shafts is respectively connected to a toothed wheel cooperating with the gear.

15. Electric mower according to claim 12, in which the synchronization mechanism is a mixed mechanism with a gear and with a notched belt.

16. Electric mower according to claim 1, comprising a cutting blade mounted on a motor blade shaft rigidly integral in rotation with a rotor of the electric motor with at least one blade respectively mounted on at least one secondary blade shaft coupled to the motor blade shaft through the intermediary of the synchronization mechanism, the synchronization mechanism forming a transmission between the motor shaft and the secondary shaft.

17. Electric mower according to claim 1, comprising a plurality of electric motors, one electric motor being respectively associated to each cutting blade.

18. Electric mower according to claim 17, comprising a control unit of the electric motors, the control unit being configured to synchronize the electric motors associated to the cutting blades.

19. Electric mower according to claim 1, in which the cutting plate comprises two counter-rotating blades and a blade protection skirt provided with a central ejection channel.

20. Electric mower according to claim 19 comprising a grass clipping collecting bin connected to the central ejection channel.

21. Electric mower according to claim 20, in which the collecting bin is fastened on the cutting unit.

22. Electric mower according to claim 1, comprising driving rear wheels coupled to the electric motor driving the cutting blades.

23. Electric mower according to claim 1, comprising driving rear wheels coupled to at least one electric motor separate from the electric motor driving the cutting blades.
